(19) United States
(12) Patent Application Publication
(10) Pub. No.: US 2022/0058075 A1
(43) Pub. Date: Feb. 24, 2022

(54) IDENTIFYING FAULTS IN SYSTEM DATA

(71) Applicant: Telefonaktiebolaget LM Ericsson (publ), Stockholm (SE)

(72) Inventors: Perepu SATHEESH KUMAR, Chennai (IN); N Hari KUMAR, Chennai (IN)

(73) Assignee: Telefonaktiebolaget LM Ericsson (publ), Stockholm (SE)

(21) Appl. No.: 17/413,426

(22) PCT Filed: Dec. 12, 2018
(86) PCT No.: PCT/IN2018/050831

§ 371 Date: Jun. 11, 2021

(51) Int. Cl. G06F 11/07

(52) U.S. Cl. CPC G06F 11/0736; G06F 11/0772; G06F 11/076

(57) ABSTRACT

A method (200) for identifying a fault in data representing a target variable of a system is disclosed. The system comprises a plurality of variables and each variable is represented by a data stream. The method comprises obtaining a reference data set for a set of variables in the system including the target variable (202), obtaining an operational data set for the set of variables in the system including the target variable (204) and, for each of the reference and operational data sets, constructing an adjacency matrix between the target variable and the other variables in the set of variables (208), wherein the adjacency matrix is constructed on the basis of a metric calculated between the target variable and the other variables of the set (208a). The method further comprises calculating a difference matrix between the adjacency matrices for the reference and operational data sets (210), and determining whether the data representing the target variable in the operational data set includes a fault on the basis of a comparison between the calculated difference matrix and a fault threshold (212).

### TECHNICAL FIELD

The present disclosure relates to a method for identifying a fault in data representing a target variable of a system. The present disclosure also relates to a controller and to a computer program and a computer program product configured, when run on a computer to carry out a method for identifying a fault in data representing a target variable of a system.

### BACKGROUND

The “Internet of Things” (IoT) refers to devices enabled for communication network connectivity, so that these devices may be remotely managed, and data collected or required by the devices may be exchanged between individual devices and between devices and application servers. Commercial, industrial and other systems are increasingly monitored and controlled using such connected devices, which may include sensors, actuators or other devices. Such devices typically have specified operating conditions, including ranges for temperature, pressure etc. within which the device will operate reliably. For example, pressure sensors tend to give good results only in the temperature range of −20° C. to +50° C. (Applied Measure Limited, 2018, https://appmeas.co.uk/resources/pressure-measurement-notes/how-does-temperature-affect-pressure-sensors/). If the ambient temperature around a sensor varies from this specified range, it is possible that the pressure readings provided by the sensor will contain errors. Certain types of faults in pressure sensor data may therefore be identified by carefully analysing the pressure sensor data in the context of corresponding temperature data.

In an operational deployment, it may be necessary to monitor a large number of system variables, giving rise to the possibility of a wide range of potential sensor interferences that may cause faults in the system data. In order to identify any underlying system issues, and take appropriate action, it is first important to identify faults in the data on the basis of which the system is assessed. Faults in the data will often be caused as a result of variations in other monitored variables or environmental factors, which themselves may need to be addressed.

Faults in system data can generally be categorised as either (i) anomalies or (ii) other, non-anomalous data faults. FIG. 1 is a sample plot of monitoring data for a variable in which faults of both categories are represented.

Anomalies are generally fluctuations in the signal such as spikes, unwanted amplitudes etc. An example of anomaly is shown on the right of FIG. 1. Identification of anomalies is facilitated by the fact that they can generally be relatively easily differentiated from the non-faulty data. Anomaly detection is a relatively well established class of fault detection.

Other data faults generally resemble the operational signal of correct data. An example of a fault of this category is illustrated on the left of FIG. 1. These faults closely resemble the normal variations of the correct data signal and so are very difficult to identify. A. Sharma et. al. (A. Sharma, L. Golubchik and R. Govindan (2007). On the Prevalence of Sensor Faults in Real-World Deployments, 4th Annual IEEE Communications Society Conference on Sensor, Mesh and Ad Hoc Communications and Networks, San Diego, Calif., 213-222) propose a method for identifying non-anomalous data faults using a clustering approach. A problem with this approach is that the clustering applications need some input arguments such as a number of clusters to be passed. In addition the performance of the method depends on the distance metric used. In another approach, Repaa et. al. (Reppa, Vasso, Marios M. Polycarpou, and Christos G. Panayiotou (2016). Sensor fault diagnosis, Foundations and Trends® in Systems and Control, 1-248) categorise faults based on a classification approach. In the method proposed by Reppa et al., the algorithm is sensitive to the shape of faults in the data and accuracy is highly dependent on the extent of the noise in the data.

### SUMMARY

It is an aim of the present disclosure to provide a method, apparatus and computer readable medium which at least partially address one or more of the challenges discussed above.

According to a first aspect of the present disclosure, there is provided a method for identifying a fault in data representing a target variable of a system, wherein the system comprises a plurality of variables, and wherein each variable is represented by a data stream. The method comprises obtaining a reference data set for a set of variables in the system including the target variable and obtaining an operational data set for the set of variables in the system including the target variable. The method further comprises, for each of the reference and operational data sets, constructing an adjacency matrix between the target variable and the other variables in the set of variables, wherein the adjacency matrix is constructed on the basis of a metric calculated between the target variable and the other variables of the set. The method further comprises calculating a difference matrix between the adjacency matrices for the reference and operational data sets, and determining whether the data representing the target variable in the operational data set includes a fault on the basis of a comparison between the calculated difference matrix and a fault threshold.

According to examples of the present disclosure, the method may further comprise an initial step of selecting a target variable.

According to examples of the present disclosure, a reference data set may comprise a data set of data collected at installation of the elements generating the data, or a data set collected at any other time when expectation of errors in the data is low. According to examples of the present disclosure, an operational data set may comprise live data from the system and may comprise the most recently available live data from the system.

According to examples of the present disclosure, the metric may comprise a combination of conditional correlation and conditional mutual information between the target variable and the other variables in the set. According to examples of the present disclosure, the correlation between the target variable and another variable may be conditioned on all other variables in the set of variables.

According to examples of the present disclosure, the metric may comprise a weighted sum of conditional correlation and conditional mutual information between the target variable and the other variables in the set.

According to examples of the present disclosure, conditional correlation between a target variable X and another variable Y may be calculated by iteratively solving the following formula:

$$ρ [ k ] = \frac{σ [ k ] - {\sum }_{l = 1}^{k - 1} ρ [ l ] σ [ k - l ]}{1 - {\sum }_{l = 1}^{k - 1} ρ [ l ] σ [ k - l ]} \qquad$$

where: σ[k] is the value of the correlation between X and Y obtained at lag k using the equation:

$${σ}_{xy} = \frac{E ( ( X - {μ}_{x} ) ( Y - {μ}_{y} ) )}{{σ}_{x} {σ}_{y}}$$

where: σₓ,σ_{y} are the standard deviation of the variables X and Y, and
μₓ,μ_{y} are the mean of the variables X and Y.

According to examples of the present disclosure, conditional mutual information between a target variable X and another variable Y conditional upon a third variable Z may calculated using the following formula:

$$I ( X ; Y \vert Z ) = {\sum }_{z ∈ Z} {\sum }_{y ∈ Y} {\sum }_{x ∈ X} {p}_{X , Y , Z} ( x , y , z ) log \frac{{p}_{Z} ( z ) {p}_{X , Y , Z} ( x , y , z )}{{p}_{X , Z} ( x , z ) {p}_{Y , Z} ( y , z )}$$

where: p_{Z}[z] is the probability mass function of variable Z, and
p_{X,Y,Z}[x, y, z] is the joint probability mass function of variables X, Y, Z

According to examples of the present disclosure, constructing the adjacency matrices may comprise using values of weights for the weighted sum that are at least one of default values, values selected on the basis of a hypothesis as to the relative importance of conditional correlation and conditional mutual information for the target variable and/or values based on an optimisation calculation.

According to examples of the present disclosure, the optimisation calculation may be a previously performed optimisation calculation, as discussed in further detail below.

According to examples of the present disclosure, calculating a difference matrix may comprise subtracting the adjacency matrix for the operational data set from the adjacency matrix for the reference data set.

According to examples of the present disclosure, determining whether the data representing the target variable in the operational data set includes a fault on the basis of a comparison between the calculated difference matrix and a fault threshold may comprise performing a comparison between the difference matrix and a fault threshold, and, if the difference matrix does not exceed the fault threshold, determining that the data representing the target variable in the operational data set does not include a fault.

According to examples of the present disclosure, determining whether the data representing the target variable in the operational data set includes a fault on the basis of a comparison between the calculated difference matrix and a fault threshold may further comprise, if the difference matrix exceeds the fault threshold, determining that the data representing the target variable in the operational data set includes a fault.

According to examples of the present disclosure, determining whether the data representing the target variable in the operational data set includes a fault on the basis of a comparison between the calculated difference matrix and a fault threshold may further comprise, if the difference matrix exceeds the fault threshold, performing an optimisation of the values of the weights for the weighted sum and constructing an updated adjacency matrix for each of the reference and operational data sets; wherein the updated adjacency matrices are constructed on the basis of a metric calculated using the optimised weight values. The determining step may further comprise recalculating the difference matrix on the basis of the updated adjacency matrices for the reference and operational data sets, performing a comparison between the recalculated difference matrix and the fault threshold, and, if the recalculated difference matrix does not exceed the fault threshold, determining that the data representing the target variable in the operational data set does not include a fault.

According to examples of the present disclosure, the method may further comprise, if the recalculated difference matrix exceeds the fault threshold, determining that the data representing the target variable in the operational data set includes a fault.

According to examples of the present disclosure, the fault threshold may comprise a value, and performing a comparison between a difference matrix and the fault threshold may comprise comparing each entry in the difference matrix to the value of the fault threshold, and the difference matrix may exceed the fault threshold if at least one entry in the difference matrix exceeds the value of the fault threshold.

According to examples of the present disclosure, the method may further comprise, if an entry in the difference matrix exceeds the value of the fault threshold, determining that the data representing the target variable in the operational data set includes a fault, and that the source of the fault in the data is the variable corresponding to the entry in the difference matrix that exceeds the threshold value.

According to examples of the present disclosure, the method may further comprise, if every entry in the difference matrix exceeds the value of the fault threshold, determining that the data representing the target variable in the operational data set includes a fault, and that the source of the fault in the data is the target variable.

According to examples of the present disclosure, the fault threshold may be selected to account for expected statistical variation in the data.

According to examples of the present disclosure, constructing an adjacency matrix between the target variable and the other variables in the set of variables may comprises filtering the other variables in the set of variables according to the value of the metric calculated between the target variable and the other variables of the set, and including in the adjacency matrix those other variables of the set of variables that have a value of the calculated metric above an inclusion threshold.

According to examples of the present disclosure, performing an optimisation of the values of the weights for the weighted sum may comprise obtaining a plurality of operational data sets for the set of variables in the system including the target variable, the plurality of operational data sets including data for the set of variables at different times during operation of the system and constructing an adjacency matrix between the target variable and the other variables in the set of variables for each of the plurality of operational data sets. Performing an optimisation may further comprise, for each of the plurality of operational data sets, calculating a difference matrix between the adjacency matrices for the reference and operational data sets, and identifying values for the weights for the weighted sum that minimise the sum, over all of the operational data sets, of the sum of all entries in each difference matrix.

According to examples of the present disclosure, identifying values of the weights for the weighted sum that minimise the sum, over all of the operational data sets, of the sum of all entries in each difference matrix may comprise solving the optimisation problem:

$$\begin{matrix}min \\ {w}_{1} , {w}_{2}\end{matrix} {\sum }_{i = 1}^{{N}_{s}} \sum {δ}_{i} such that \begin{matrix}0 \leq {w}_{1} \leq 1 \\ 0 \leq {w}_{2} \leq 1 \\ {w}_{1} + {w}_{2} = 1\end{matrix}$$

where: Nₛ is the number of operational data sets;
δᵢ is the difference matrix for operational data set i; and
w₁ and w₂ are the weights of the weighted sum.

According to examples of the present disclosure, the weight values for construction of the initial adjacency matrices in the optimisation problem may be those used in the adjacency matrices for the first comparison, that is, according to different examples, default values, values based on a hypothesis values based on a previous optimisation.

According to examples of the present disclosure, example time intervals for the plurality of operational data sets may include every 2 minutes, 5, minutes, 10 minutes etc.

According to examples of the present disclosure, the method may further comprise, if it is determined that the data representing the target variable in the operational data set includes a fault, repeating the steps of the method for operational data sets at different time instances to identify the time instance at which the difference matrix first exceeds the fault threshold.

According to examples of the present disclosure, the system may comprise an Internet of Things (IoT) system.

According to examples of the present disclosure, the variables may comprise sensor measurements.

According to examples of the present disclosure, the method may further comprise selecting a new target variable, and repeating the steps of the method for the new target variable.

According to examples of the present disclosure, in the event of a single entry in the difference matrix exceeding the threshold value, the variable corresponding to that entry may be selected as the next target variable.

According to examples of the present disclosure, the method may further comprise obtaining an updated operational data set, and repeating the steps of the method with the updated operational data set.

According to examples of the present disclosure, the method may further comprise triggering an alarm if a fault is detected in the data, and/or triggering some remedial action to address a source or cause of the fault.

According to another aspect of the present disclosure, there is provided a computer program comprising instructions which, when executed on at least one processor, cause the at least one processor to carry out a method according to any one of the preceding aspects or examples of the present disclosure.

According to another aspect of the present disclosure, there is provided a carrier containing a computer program according to the preceding aspect of the present disclosure, wherein the carrier comprises one of an electronic signal, optical signal, radio signal or computer readable storage medium.

According to another aspect of the present disclosure, there is provided a computer program product comprising non transitory computer readable media having stored thereon a computer program according to a preceding aspect of the present disclosure.

According to another aspect of the present disclosure, there is provided a controller for identifying a fault in data representing a target variable of a system, wherein the system comprises a plurality of variables, and wherein each variable is represented by a data stream. The controller comprises a processor and a memory, the memory containing instructions executable by the processor such that the controller is operable to obtain a reference data set for a set of variables in the system including the target variable, obtain an operational data set for the set of variables in the system including the target variable, and, for each of the reference and operational data sets, construct an adjacency matrix between the target variable and the other variables in the set of variables, wherein the adjacency matrix is constructed on the basis of a metric calculated between the target variable and the other variables of the set. The controller is further operable to calculate a difference matrix between the adjacency matrices for the reference and operational data sets, and determine whether the data representing the target variable in the operational data set includes a fault on the basis of a comparison between the calculated difference matrix and a fault threshold.

According to examples of the present disclosure, the controller is further operable to carry out a method according to any one of the preceding aspects or examples of the present disclosure.

According to another aspect of the present disclosure, there is provided a controller for identifying a fault in data representing a target variable of a system, wherein the system comprises a plurality of variables, and wherein each variable is represented by a data stream. The controller is adapted obtain a reference data set for a set of variables in the system including the target variable, obtain an operational data set for the set of variables in the system including the target variable and, for each of the reference and operational data sets, construct an adjacency matrix between the target variable and the other variables in the set of variables, wherein the adjacency matrix is constructed on the basis of a metric calculated between the target variable and the other variables of the set. The controller is further adapted to calculate a difference matrix between the adjacency matrices for the reference and operational data sets, and determine whether the data representing the target variable in the operational data set includes a fault on the basis of a comparison between the calculated difference matrix and a fault threshold.

According to examples of the present disclosure, the controller is further operable to carry out a method according to any one of the preceding aspects or examples of the present disclosure.

### BRIEF DESCRIPTION OF THE DRAWINGS

For a better understanding of the present invention, and to show more clearly how it may be carried into effect, reference will now be made, by way of example, to the following drawings, in which:

FIG. 1 is a sample plot of monitoring data for a variable in which faults of different categories are represented;

FIG. 2 is a flow chart illustrating process steps in a method for identifying a fault in data representing a target variable of a system;

FIGS. 3a to 3d show a flow chart illustrating process steps in another example of method for identifying a fault in data representing a target variable of a system;

FIG. 4 illustrates an example undirected graph for a target variable;

FIG. 5 illustrates simulated temperature data for a boiler;

FIG. 6 illustrates an example undirected graph for boiler temperature and other variables;

FIG. 7 illustrates another example undirected graph for boiler temperature and other variables, constructed using a different metric;

FIG. 8 illustrates the data of FIG. 5 with an introduced fault;

FIG. 9 illustrates another example undirected graph for boiler temperature and other variables, constructed using an operational data set including the faulty data of FIG. 8;

FIG. 10 is a system flow diagram summarizing an implementation of a method for identifying a fault in data representing a target variable of a system;

FIG. 11 is a block diagram illustrating functional units in a controller; and

FIG. 12 is a block diagram illustrating functional units in another example of controller.

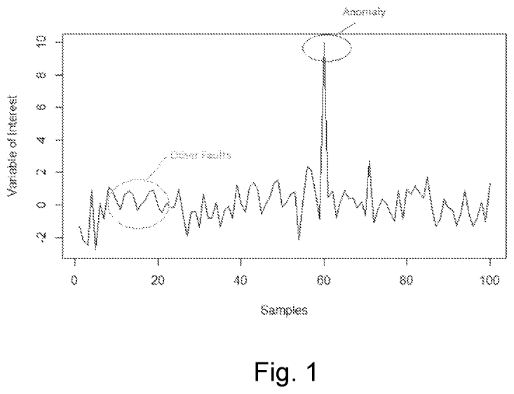

### DETAILED DESCRIPTION

Aspects of the present disclosure provide a method according to which a fault in system data is identified on the basis of a change in dependency between a target variable and other variables in the system. Thus instead of attempting to identify faults in a data stream on the basis of the data stream alone, aspects of the present disclosure consider how the interdependency of the data stream with data streams representing other system variables evolves over time. The evolution over time in the interdependency of variables is examined though two data sets: a first data set comprising data recorded during a phase in which the expectation of errors in the data is low, and a second data set recorded during an operational phase of the system. The first data set forms a reference data set, and may for example be collected during an installation phase. Adjacency matrices are then constructed for each of the data sets, based on a metric calculated between a target variable in the system and other variables in the system represented by each data set. Any difference between the adjacency matrices is then examined as an indication of a potential fault in the data.

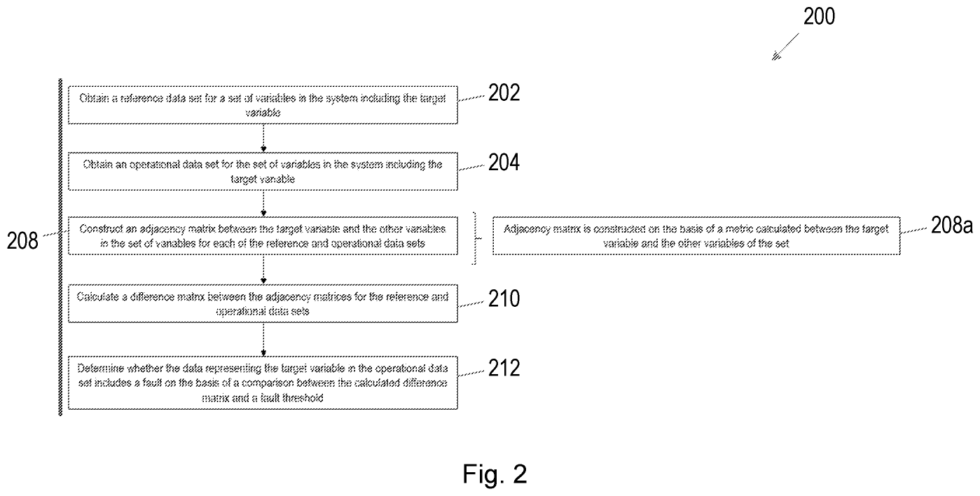

FIG. 2 is a flow chart illustrating process steps in a method 200 for identifying a fault in data representing a target variable of a system, wherein the system comprises a plurality of variables, and wherein each variable is represented by a data stream. The system may for example be an Internet of Things (IoT) system comprising a plurality of devices, each device providing a data stream representing a system variable. The method may for example be performed by a controller. The controller may be deployed on any node with access to data from the system. With reference to FIG. 2, the method 200 comprises, in a first step 202, obtaining a reference data set for a set of variables in the system including the target variable. The method further comprises obtaining an operational data set for the set of variables in the system including the target variable at step 204. In step 208, the method 200 comprises, for each of the reference and operational data sets, constructing an adjacency matrix between the target variable and the other variables in the set of variables. As illustrated at step 208a, the adjacency matrix is constructed on the basis of a metric calculated between the target variable and the other variables of the set. The method 200 further comprises, at step 210, calculating a difference matrix between the adjacency matrices for the reference and operational data sets, and, in step 212, determining whether the data representing the target variable in the operational data set includes a fault on the basis of a comparison between the calculated difference matrix and a fault threshold.

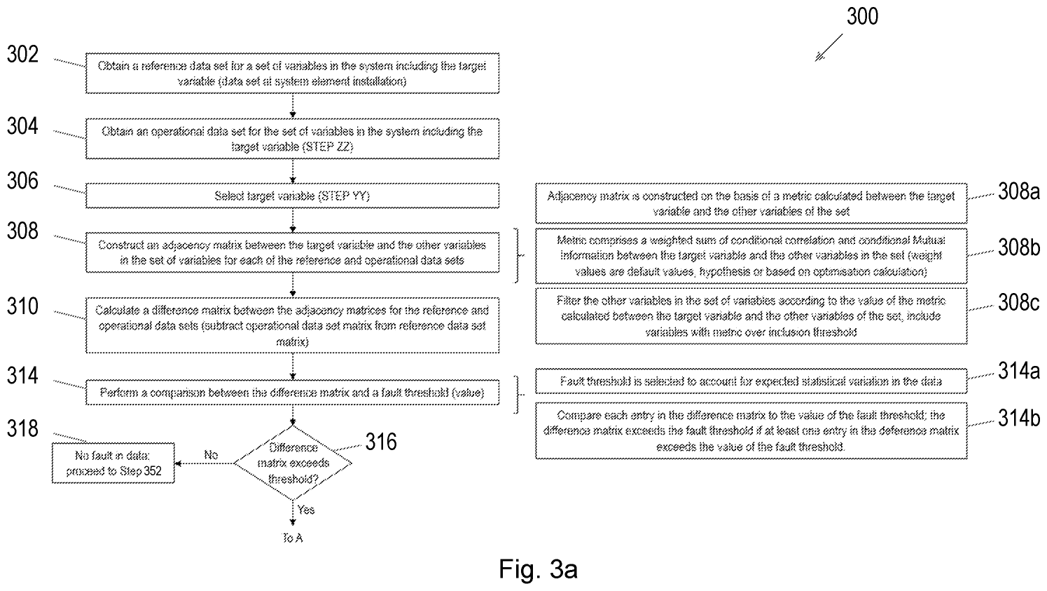

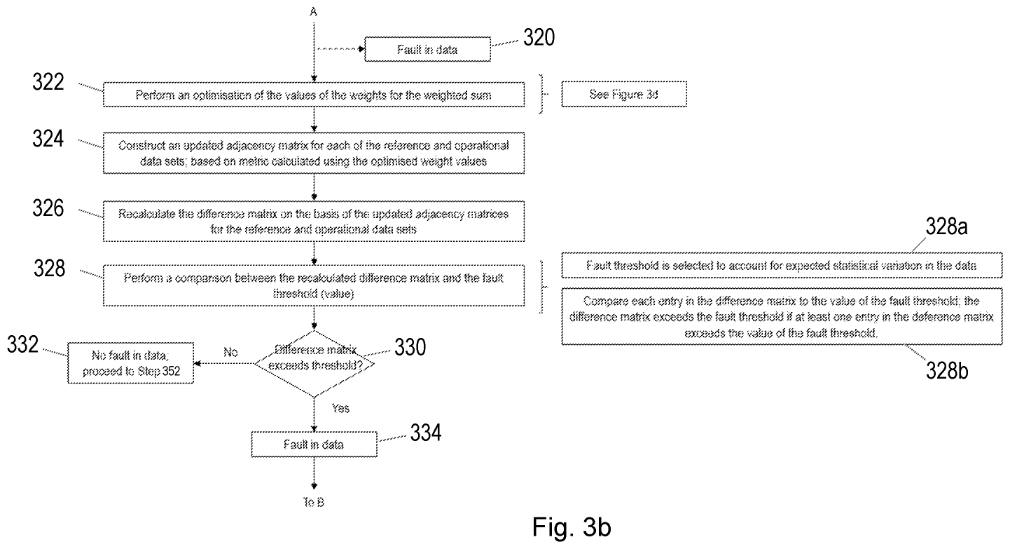

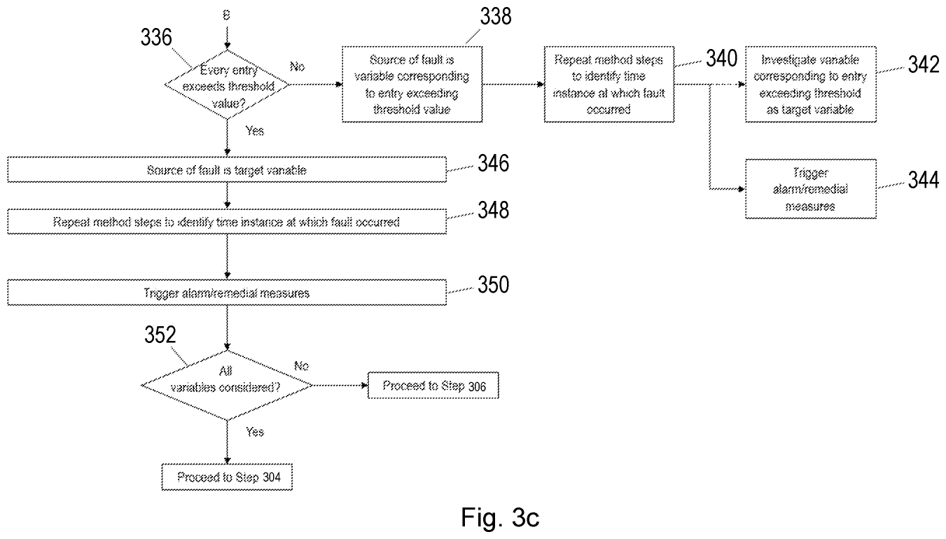

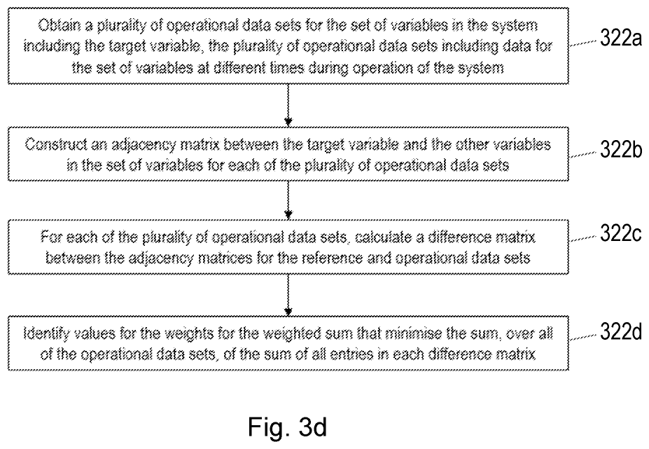

FIGS. 3a to 3c show a flow chart illustrating process steps in another example of a method 300 for identifying a fault in data representing a target variable of a system, wherein the system comprises a plurality of variables, and wherein each variable is represented by a data stream. The steps of the method 300 illustrate one way in which the steps of the method 200 may be implemented and supplemented in order to achieve the above discussed and additional functionality. As for the method 200 of FIG. 2 above, the method 300 may be performed by a controller. The controller may be deployed on any node with access to data from the system.

Referring to FIG. 3a, in a first step 302, the controller obtains a reference data set of a set of variables in the system including the target variable. The set of variables may include all variables in the system or may exclude one or more variables in the system. As discussed, the reference data set may comprise data recorded during a phase in which the expectation of errors in the data is low. This may for example comprise an installation phase of the devises, such as sensors or actuators, supplying the data. In in other examples, the reference data may be obtained during a different phase in which the expectation of errors in the data is low, such as following a debugging operation etc. In step 304, the controller obtains an operational data set for the set of variables in the system including the target variable. The operational data set may for example comprise the most recent live operating data from the system, and may be updated periodically or in a scheduled manner, such as for example every 2, 5 or 10 minutes or at certain specific times. The operational data set may or may not contain faults or errors in the data.

In step 306, the controller selects a target variable for investigation. The target variable may be selected at random, or on a sequential basis in which all variables in the system are selected one after the other, or on the basis of insight obtained from system analysis or from an earlier iteration of the method (as discussed below with reference for example to step 342). In some examples, the selection of a target variable may be performed before the reference and operational data sets are obtained, and the variables to be included in the reference and operational data sets may be selected on the basis of the selected target variable. For example, any variables which may potentially impact the selected target variable may be included in the set of variables for the reference and operational data sets. In step 308, the controller constructs an adjacency matrix between the target variable and the other variables in the set of variables for each of the reference and operational data sets. As illustrated at 308a, the adjacency matrices are constructed on the basis of a metric calculated between the target variable and the other variables of the set.

The adjacency matrices may thus quantify the dependencies between the variables. The metric comprises a combination of the conditional correlation and conditional mutual information between the target variable and the other variables in the set. In the illustrated example, the combination is a weighted sum:

M=w₁(M.C)+w₂(C.C)

Where: M is the value of the metric
M.C is the conditional mutual information
C.C is the conditional correlation, and
w1 and w2 are weights used for the weighted sum.

The values of the weights w1, w2 may be values based on a hypothesis about the relative importance of conditional correlation and conditional mutual information to the target variable, or may be based on a previously performed optimisation (as discussed in further detail with reference to FIG. 3d). In some examples, the values of the weights w1, w2 may be default values. For example default values of w1=1 and w2=1 may be selected to calculate a simple sum of the conditional correlation and conditional mutual information. In some example implementations of the method, the values of the weights may be selected according to the particular application in which the faults are to be detected, or according to the nature of the target variable. For example, in some systems, conditional correlation may more accurately reflect the interdependencies between variables than conditional mutual information, and in other systems the reverse may be true. The details of calculating conditional correlation and conditional mutual information, including example equations, are provided below, following the present discussion of FIGS. 3a to 3c.

As illustrated at 308c, the controller may filter the other variables in the set of variables according to the value of the metric calculated between the target variable and the other variables, before constructing the adjacency matrices. The adjacency matrices may be constructed on the basis of variables having a value of the metric calculated with the target variable over an inclusion threshold. The inclusion threshold may be selected in any appropriate manner, and may for example be expressed as a maximum number of variables, such that the variables associated with the X highest calculated metric values are included in the adjacency matrix, or may be a metric value, such that all variables having a metric value over the threshold are included in the adjacency matrix. Other examples for calculating and representing the inclusion threshold may be envisaged.

The adjacency matrices may describe an undirected graph of the variables in the set, in which each variable comprises a node and the edges between the variables are weighted according to the value of the calculated metric.

Referring still to FIG. 3a, in step 310, the controller calculates a difference matrix between the adjacency matrices for the reference and operational data sets. This may comprise subtracting the operational data set matrix from the reference data set matrix. Thus for a reference adjacency matrix A1 and an operational adjacency matrix A2, the difference matrix δ is calculated as:

δ=A₁−A₂

If M.C and C.C are the matrices of values of conditional mutual information and conditional correlation for the data sets, the difference matrix δ may be expressed as:

δ=w₁(M.C)₁+w₂(C.C)₁−w₁(M.C)₂−w₂(C.C)₂

In step 314, the controller performs a comparison between the difference matrix and a fault threshold. This comparison is then used to determine whether the data representing the target variable includes a fault, as set out in the following method steps.

As illustrated in 314a, a value of the fault threshold may be selected to account for expected statistical variation in the data. For example, it may be expected that the dependency between the variables may vary a small amount, purely on the basis of expected statistical variation in the data. The fault threshold may be selected such that this expected variation does not cause the difference metric to exceed the fault threshold. A bootstrapping technique may be used to compute the threshold. An example bootstrapping technique involves generation of artificial samples from the existing data by changing measurement errors in the data. As illustrated at 314b, performing a comparison may comprise comparing each entry in the difference matrix to the value of the fault threshold. The difference matrix is considered to exceed the fault threshold if at least one entry in the difference matrix exceeds the value of the fault threshold.

In step 316, the controller checks whether or not the difference matrix exceeds the threshold. If the difference matrix does not exceed the threshold, then the controller concludes that there is no fault in the data representing the target variable, and the controller proceeds to step 318 of the method. Step 318 is described in further detail below, and comprises checking whether all variables in the system have been considered, allowing for, if appropriate, the selection of a new target variable and the performance of the method to investigate the possibility of faults in the data of the newly selected target variable. If the difference matrix exceeds the threshold, the controller may determine in step 320 that there is a fault in the data, and may take appropriate action, as discussed below in steps 340 to 350. In other examples, the controller may first establish that the difference is not caused by a sub-optimal choice of weights for use in the weighted combination metric, as set out below.

In step 322, the controller performs an optimization of the values of the weights for the weighted sum that is calculated as the metric for constructing the adjacency matrices. The details of this optimization procedure are discussed below, with reference to FIG. 3d. The result of the optimization procedure is new values of the weights w1 and w2 for use in calculating the metric between the target variable and the other variables in the variable set. On the basis of these optimized weights, the controller then constructs, at step 324, an updated adjacency matrix for each of the reference and operational data sets. In step 326, the controller then recalculates the difference matrix on the basis of the updated adjacency matrices for the reference and operational data sets. In step 328, the controller performs a comparison between the recalculated difference matrix and the fault threshold. The fault threshold may be the same threshold as was used in step 314 or may be different. A similar bootstrapping procedure to that described above may also be used to select the fault threshold for step 328. As discussed above with reference to step 314, performing a comparison may comprise comparing each entry in the difference matrix to the value of the fault threshold. The difference matrix is considered to exceed the fault threshold if at least one entry in the difference matrix exceeds the value of the fault threshold.

If the controller determines at step 330 that the recalculated difference matrix does not exceed the fault threshold, then the value or values in the original difference matrix that caused the matrix to exceed the threshold were a consequence of inappropriate weighting values, and the controller thus determines at step 332 that the data representing the target variable in the operational data set does not include a fault. If the recalculated difference matrix exceeds the fault threshold, then the value or values in the original difference matrix that caused the matrix to exceed the threshold were a not consequence of inappropriate weighting values, and the controller determines at step 334 that the data representing the target variable in the operational data set includes a fault.

Referring now to FIG. 3c, the controller then proceeds to determine the origin or cause of the fault in the data. If an entry in the adjacency matrix is unchanged between the reference and operational datasets, that is if the corresponding entry in the difference matrix is zero (or within a margin of statistical variation), then the relation between the target variable and the corresponding other or influencing variable is unchanged. It may therefore be inferred that the influencing variable is not causing a change in the target variable. If an entry in the adjacency matrix changes between the reference and operational datasets, that is if the corresponding entry in the difference matrix is non zero (and above a margin of statistical variation), then the relation between the target variable and the corresponding other or influencing variable has changed. If only that relation has changed, then the change in the relation may be attributed to the effect of the influencing variable on the target variable. If the relation of all the variables to the target variable changes, then the change can be attributed to a fault in the target variable.

In step 336, the controller checks whether or not every entry in the difference matrix exceeds the fault threshold. If not every entry in the difference matrix exceeds the threshold, then the controller determines in step 338 that the source of the fault in the data is the variable corresponding to the entry in the difference matrix that exceeds the threshold value. In step 340, the controller repeats the steps of the method for operational data sets at different time instances to identify the time instance at which the difference matrix first exceeds the fault threshold. This time instance represents the time at which the identified variable began to affect the readings for the target variable. This insight may assist with further fault investigation and/or identifying correct data for the target variable on the basis of which operational decisions may be made. The controller may then investigate the identified variable as a target variable in step 342. This step comprises returning to step 306 of the method and selecting the identified variable as the target variable, before continuing with the steps of the method as described. If the identified variable is the source of the error in the original target variable data, then it is possible that other variables may have been affected, and this may be represented in the evolution of the dependencies between the identified variable and the other variables of the system, as illustrated by a difference matrix constructed according to examples of the present disclosure. Alternatively, or in addition, the controller may trigger an alarm or may directly trigger remedial measures on the basis of the identified fault in the original target variable data and the identified variable that is the source of the fault.

Returning to step 336, if the controller determines that every entry in the difference matrix exceeds the value of the fault threshold, then the controller determines at step 346 that the source of the fault in the data is the target variable. The controller then proceeds, in step 348, to repeat the steps of the method for operational data sets at different time instances to identify the time instance at which the difference matrix first exceeds the fault threshold. As discussed above with reference to step 340, this repetition allows the controller to identify the time instance at which the error in the data begins and the target variable begins to potentially affect the validity of data for other variables. For example if a temperature sensor has exceeded its operational threshold, its own readings may contain faults, but other devices may also have exceeded their operational thresholds for temperature, meaning that their data may also be investigated to determine whether or not errors appear in their data at around the same time. In step 350, the controller may trigger an alarm or remedial measures as previously discussed.

In step 352, the controller checks whether all variables have been considered. This may be a check on all variable sin the system, or all variables from a set of variables for which the accuracy of the data is to be investigated. If all variables have not yet been considered, the controller returns to step 306 and selects and new target variable before executing the remaining method steps as described above. If all variables have been considered, then the controller returns to step 306 to obtain a newly updated operational data set and proceed with the selection of a target variable and the remaining method steps, so checking for a fault in the system data at a new time increment.

The above described example methods 200 and 300 represent a robust, data driven approach to the identification of faults that cannot be classified as anomalies in system data. No input arguments are required from a user and the method is applicable to any kind of variable, including those that do not lend themselves to clustering or other currently used analysis techniques for non-anomalous data errors.

A detailed discussion of an example metric and its calculation is now provided. This discussion applies to the metric which is calculated between the target variable and other variables in the system in order to construct the adjacency matrices according to examples of the present disclosure. The construction of adjacency matrices as described above is anomalous to the construction of a graph, and a graph is used in the following discussion to illustrate the example metric.

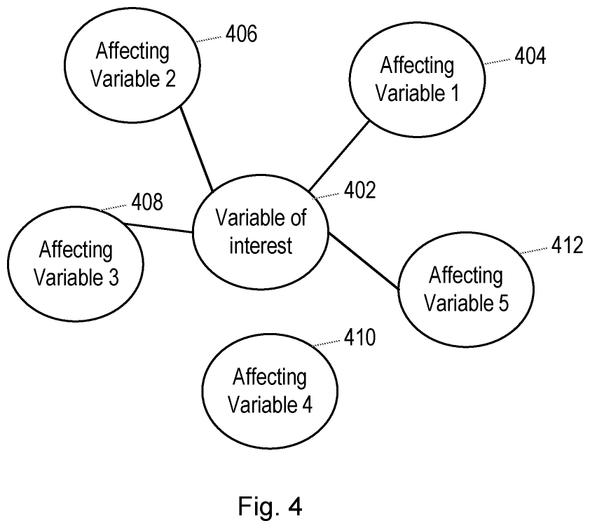

FIG. 4 illustrates an example undirected graph in which the central node 402 is the target variable or variable of interest, and the other nodes 404, 406, 408, 410, 412 are the variables influencing the variable of interest 402. The influencing nodes are connected to the node 402 representing the target variable with edges which have varying strengths. As already discussed, a metric, which may comprise a weighted sum of conditional correlation and conditional mutual information, is used to compute the strength of the edges of the graph. The thick edges between nodes 406 and 402 and between nodes 412 and 402 correspond to the influencing nodes 406 and 412 which are connected most strongly to the target node 402. The thinner edges connect nodes which are more weakly connected to the target node. A strong connection between an influencing node and the target node indicates that the variables represented by these nodes have a strong interdependency. Conversely, a weak connection between nodes indicates a weak interdependency.

After initial metric calculation and graph construction, the variables influencing the central node may be filtered based on the values of the adjacency matrix. For example, if the strength is low, it can be inferred that the interdependency between the target variable and the relevant influencing variable is low. A threshold may be set such that only the nodes connected by the X strongest edges are retained, or only nodes connected with an edge strength over a threshold value are maintained. In this manner, a subset graph is obtained with fewer nodes, simplifying subsequent analysis and computation.

According to examples of the present disclosure, the metric used for construction of the graph is a weighted sum of conditional correlation and conditional mutual information. The importance of this metric is explored below, followed by a detailed discussion of how it may be calculated.

An example system is proposed comprising three variables x, y, z and a data generating process of:

x=2z+e₁

y=3z+e₂

In this process, e₁, e₂ are white noise vectors and variables x and y are generated by the equations given above. In this example system, it is noted that the variables x and y are not related directly, but rather are related by the variable z.

Data was generated for the variables x, y and z, correlation values σ_{xy}, σ_{yz} and σ_{xz} were computed. Correlation gives an indication of linear connections between variables. For this example system, the correlations values were computed as σ_{xy}=0.95, σ_{yz}=0.97 and σ_{xz}=0.98.

It will be appreciated that although the variables x and y are not connected directly, the correlation value between x and y is high (0.95), suggesting that these variables are strongly connected. Correlation alone can thus lean to misleading results during graph construction as a high correlation value can be obtained even when two variables are not connected directly.

The conditional correlation value between the variables x and y is much lower than the standard correlation. The conditional correlation between x and y was calculated as 0.02. Using conditional correlation may therefore provide a more accurate representation of interdependencies, and so a more accurate adjacency matrix and graph.

In one example of the present disclosure, it is proposed to use Pearson's correlation to compute the estimate of the correlation. The Pearson's correlation between two variables X and Y is computed as

$${σ}_{xy} = \frac{E ( ( X - {μ}_{x} ) ( Y - {μ}_{y} ) )}{{σ}_{x} {σ}_{y}}$$

where σₓ, σ_{y} are the standard deviation of the random variables X and Y respectively and μₓ, μ_{y} are the mean of the variables X and Y respectively. As mentioned above, correlation has the disadvantage of modelling both direct and indirect linear dependencies. For the purposes of the metric used to calculate adjacency matrices in examples of the present disclosure, it is desirable to represent direct connection between two variables. Examples of the present disclosure therefore calculate the conditional correlation (or partial correlation) between a target variable and another variable, quantifying only the direct linear dependencies rather than the total dependencies between the variables. The conditional or partial correlation computes the correlation between two variables conditioned on all other variables, so measuring direct linear dependencies.

There are several ways of measuring partial correlation between two variables. In examples of the present disclosure, it is proposed to use the computation method disclosed in Ha, Min Jin, and Wei Sun. “Partial Correlation Matrix Estimation Using Ridge Penalty Followed by Thresholding and Reestimation.” Biometrics 70.3 (2014): 762-770. PMC. Web. 4 Apr. 2018. The expression used in this reference is a robust measure of partial correlation. The partial or conditional correlation may therefore be calculated using the expression:

$$ρ [ k ] = \frac{σ [ k ] - {\sum }_{l = 1}^{k - 1} ρ [ l ] σ [ k - l ]}{1 - {\sum }_{l = 1}^{k - 1} ρ [ l ] σ [ k - l ]} \qquad$$

This formula is solved iteratively to obtain the conditional correlation at lag k. In this formula, σ[k] is the value of the correlation obtained at lag k. The formula is used to calculate the conditional correlation between every pair of variables by calculating the correlation between two variables.

Conditional correlation provides an indication of direct linear dependencies in the time domain. In many systems, the variables for analysis may additionally be connected in a non-linear fashion. Mutual information is a measure used to quantify the non-linear dependencies between variables, as set out in Cover, T. M., & Thomas, J. A. (2012). Elements of information theory. John Wiley & Sons. However, mutual information has the same disadvantage as correlation, in that is models both direct and indirect dependencies. Examples of the present disclosure therefore propose to use conditional mutual information to model direct non-linear dependencies.

Mutual information between two variables works on the principle of computing correlation on the probability distribution functions of the variables, so estimating the non-linear dependencies between them. The conditional mutual information between two random variables X and Y conditioned on another variable Z is computed as given in Cover and Thomas, 2012, as:

$$I ( X ; Y \vert Z ) = {\sum }_{z ∈ Z} {\sum }_{y ∈ Y} {\sum }_{x ∈ X} {p}_{X , Y , Z} ( x , y , z ) log \frac{{p}_{Z} ( z ) {p}_{X , Y , Z} ( x , y , z )}{{p}_{X , Z} ( x , z ) {p}_{Y , Z} ( y , z )}$$

It will be appreciated that the calculation of conditional mutual information requires calculation of probability density function, which can be difficult to calculate. Conditional mutual information is therefore a less robust measure, as the value of conditional mutual information changes with small change of the estimated probability density function. It may be desirable to seek to correct for the potential error in the calculation of conditional mutual information.

From the above discussion, it may be appreciated that conditional correlation is calculated from measured readings and is therefore a robust measure, whereas the conditional mutual information is calculated from an estimated probability density function (it may also be estimated from data). Conditional mutual information is not therefore a robust measure. However, conditional mutual information may be of greater usefulness, as it quantifies direct, non-linear dependencies, whereas conditional (partial) correlation is limited to direct linear dependencies. Examples of the present disclosure therefore propose to combine the conditional correlation and conditional mutual information in a weighted manner, so balancing the robustness offered by conditional correlation with the non-linear dependencies quantified by conditional mutual information.

Some examples of the present disclosure propose to use a weighted sum to combine conditional correlation and conditional mutual information. As discussed above, the initial weights for the sum may be selected to be default values (for example 1), or may be selected on the basis of some hypothesis or theory as to the relative importance of conditional correlation and conditional mutual information to the particular target variable under consideration. In other examples, the weights may be chosen according to a previously performed optimization procedure. Weight optimization is performed according to some examples of the present disclosure in the event of an initial comparison between a difference matrix and a fault threshold that suggest the presence of a fault in the data. A high value entry in a difference matrix, which entry is above a fault threshold value, may be case by a fault in the data, but it may also be caused by an inappropriate choice of weights for the weighted sum. The optimal weights for the weighted sum will depend upon the details of the underlying system the data of which is being analyzed for fault detection. An optimization procedure allows this possibility to be discounted, ensuring that a difference matrix that exceeds a fault threshold is truly indicative of a fault in the data. Referring again to FIG. 3b, the optimization process is conducted according to the method 200 after an initial comparison indicating that a difference matrix exceeds a fault threshold.

FIG. 3d illustrates process steps that maybe carried out as a part of the optimization procedure. As a reminder, the metric used for the construction of the adjacency matrices according to the method 200 is a weighted sum of conditional mutual information and conditional correlation:

M=w₁(M.C)+w₂(C.C)

Where M is the computed metric, M.C. is conditional mutual information, C.C. is the conditional correlation, and w₁, w₂ are the weights used in the computation.

With reference to FIG. 3d, in a first step 322a of the optimization procure, the controller obtains a plurality of operational data sets for the set of variables in the system including the target variable, the plurality of operational data sets including data for the set of variables at different times during operation of the system. In step 322b, the controller constructs an adjacency matrix between the target variable and the other variables in the set of variables for each of the plurality of operational data sets. The value of the weights used to compute the metric for the adjacency matrices may be some value between 0 and 1 that is a default value, hypothesis value or a value from a previous optimization, as discussed above. In step 322c, the controller calculates, for each of the plurality of operational data sets, a difference matrix between the adjacency matrices for the reference and operational data sets, resulting in a plurality of difference matrices, one difference matrix for each of the operational data sets obtained.

As noted above, a difference matrix between a reference adjacency matrix A1 and an operational adjacency matrix A2 is calculated as:

δ=A₁−A₂

δ=w₁(M.C)₁+w₂(C.C)₁−w₁(M.C)₂−w₂(C.C)₂

Thus, for the plurality of Ns operational data sets, Ns difference matrices are obtained:

δᵢ=w₁(M.C)_{PD}+w₂(C.C)_{PD}−w₁(M.C)ᵢ−w₂(C.C)ᵢ, i=1,2, . . . ,Nₛ

A difference matrix having entries over a fault threshold may be obtained as a consequence of a fault in the data or as a consequence of using non-optimal weights in the calculation of the metric used to construct the adjacency matrices. In order to minimize the effect of the weights on the difference matrices, an optimization problem may be used to identify values for the weights for the weighted sum that minimize the sum, over all of the operational data sets, of the sum of all entries in each difference matrix. This equates to attempting minimize, for different weight values, the deviation from the adjacency matrix obtained from the reference dataset. This optimization problem may be expressed as:

$$\begin{matrix}min \\ {w}_{1} , {w}_{2}\end{matrix} {\sum }_{i = 1}^{{N}_{s}} \sum {δ}_{i} such that \begin{matrix}0 \leq {w}_{1} \leq 1 \\ 0 \leq {w}_{2} \leq 1 \\ {w}_{1} + {w}_{2} = 1\end{matrix}$$

The constraints ensure that the weights obtained are between the limits 0 to 1.

The result of the optimization problem is the optimal value of weights w1 and w2 for the system and target variable under consideration. As discussed above with reference to FIG. 3b and FIG. 3c, these optimal weights may be used to recalculate the adjacency matrices of the primary and most recent secondary data sets, allowing for the calculation of an updated difference matrix. If the difference matrix still exceeds the fault threshold, then it may be inferred that this is as a consequence of a fault in the data, and not caused by the selection of inappropriate values for the weights w1 and w2.

An example implementation of a method according to the present disclosure is discussed below. In the example implementation, the method is performed by a node which may be deployed anywhere in the system. The only requirement on the node deployment is that it should have a direct connection to data from the system. The node should be capable of performing the computations necessary to carry out the method. Data from the system is fed into the node and calculations to perform the method are performed on the node itself, or may in some other examples be outsources to a virtualized function or resource. Depending on the output of the node, an alarm may be triggered which will indicate to an end user the presence of a fault in the system data. The alarm can be in the form of a message or messages, some action to move sensors such that the effect of the fault can be mitigated etc. Any update to the node can be done on the fly to tune the parameters of the method.

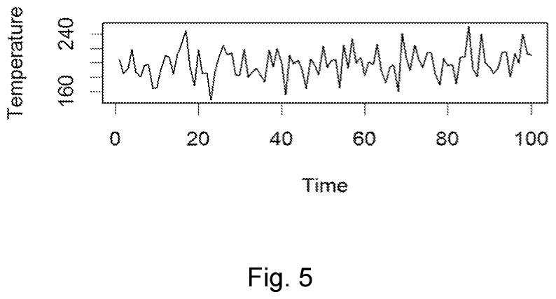

The example implementation is performed don a synthetic data set in which the target variable is the temperature of water in a boiler. Other variables in the system include outside temperature, pressure of the water in the boiler and level of the water in the boiler. To demonstrate the performance of the example method in identifying dummy factors, the flow of water into another boiler is also considered as a potential influencing variable. The simulated temperature of the boiler is illustrated in FIG. 5.

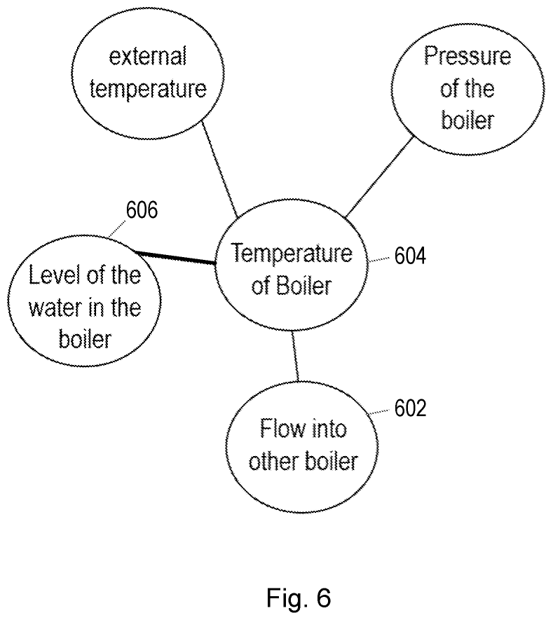

A reference data set is obtained comprising data values obtained at a simulate installation phase, and an undirected graph is constructed between the boiler temperature and other variables. The graph is constructed on the basis of a metric comprising a weighted combination of conditional correlation and conditional mutual information as discussed above. For this initial calculation, estimated weight values of w1=1 and w2=1 are used. The constructed graph is shown in FIG. 6.

The graph provides a visual representation of the adjacency matrix for the primary dataset, with the thickness of the edges connecting nodes representing the magnitude of the values in the adjacency matrix for the metric calculate between the connected nodes. It can be seen from the constructed graph that the flow into the boiler 602 has only minimum effect on the temperature 604, whereas the level of the water in the boiler 606 has maximum effect. The graph matches with the physics of a genuine boiler system: a boiler surface is generally highly insulated and outside environmental temperature changes have reduced effect on the inside boiler temperature. In contrast, the level of the water in the boiler has direct influence on the temperature of the boiler.

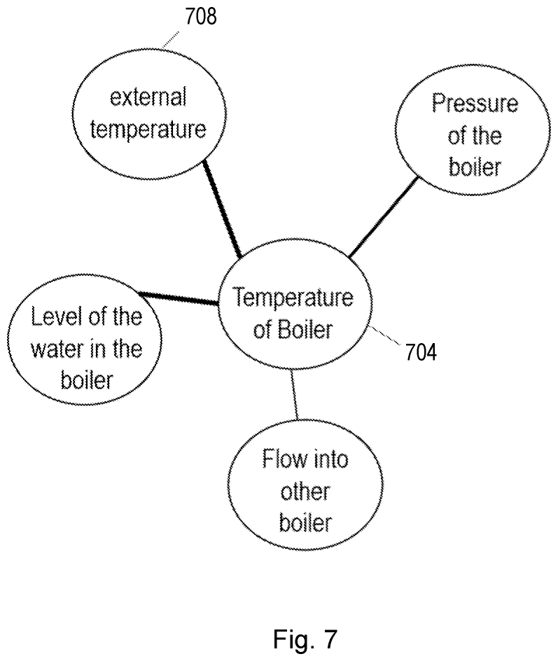

For the sake of comparison, FIG. 7 illustrates a similar graph constructed using a metric of conditional correlation only, as opposed to the weighted sum of conditional correlation and mutual information that was used to construct the graph of FIG. 6. It can be seen from FIG. 7 that the external temperature 708 is indicated as having strong influence on the temperature of water in the boiler 704. This does not agree with the physics of the system, in which the insulation between the boiler and the external environment means the external temperature can have only limited effect on the water temperature inside the boiler. The metric of a weighted sum or conditional correlation and conditional mutual information, used to construct the graph of FIG. 6, therefore provides a more accurate representation of the system.

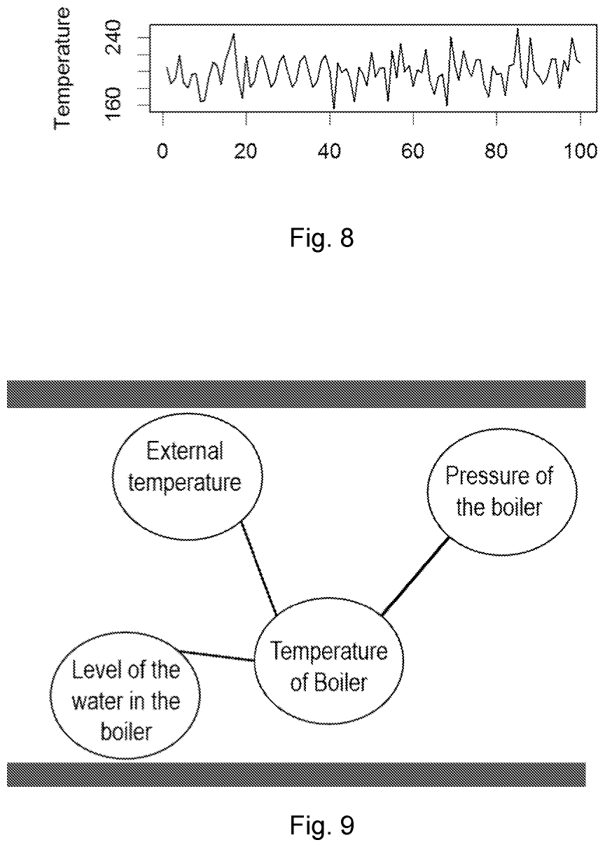

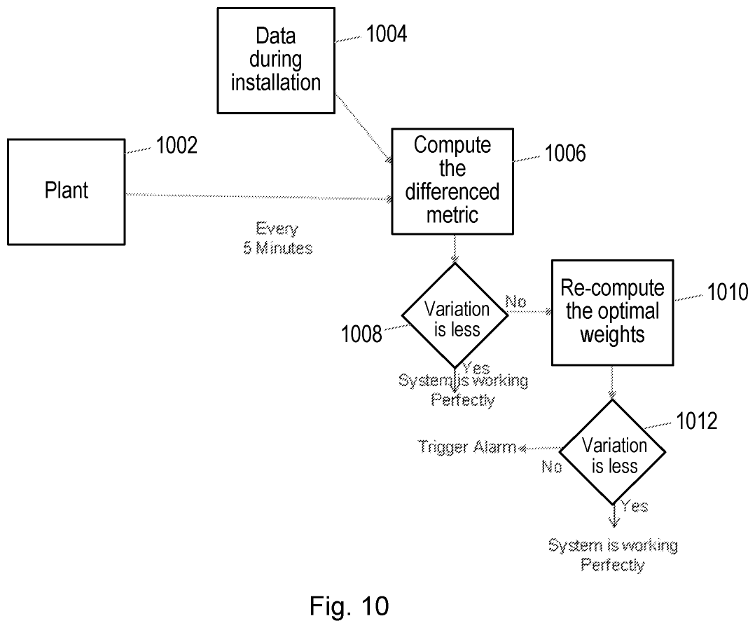

An artificial fault is then introduced in the temperature of the boiler between 21-40 seconds, as illustrated in FIG. 8. An undirected graph is constructed using an operational data set including the faulty data. The graph is filtered to maintain only the most closely connected nodes and is illustrated in FIG. 9.

The difference between the two graphs is computed and the difference is analyzed for the factors affecting the process. Updated weight values of w1=0.7 and w2=0.3 are used. The strength of the connection between the temperature of the boiler appears to decrease with the level of the water in the boiler following the introduction of the faulty data. A fault may therefore be expected in the target variable of boiler water temperature. In this example illustration the relevant value of the adjacency matrix, that is the value of the weighted sum metric, was calculated as 1.45 in the reference data set and 0.67 in the operational data set. A fault threshold of 0.08 is used. An optimization process is then performed as discussed above to determine optimal weights. The optimization process returns optimal weight values of w1=0.45 and w2=0.55.

The adjacency matrices for the reference and operational data sets are then reconstructed using the optimal weights, and the difference matrix is calculated on the basis of the updated adjacency matrices. The relevant value of the adjacency matrix, that is the value of the weighted sum metric, was calculated as 1.45 in the reference data set and 0.82 in the operational data set. A fault threshold of 0.06 is used, meaning the relevant entry in the difference matrix is above the fault threshold and indicates a fault in the data. The exact time at which the fault occurs can be obtained by iteratively computing the operational data set adjacency matrix for different time instances. This iteration concludes that the temperature in the boiler has a fault between the times 21 and 40 seconds, which matches with the original data. The source of the fault is assigned to the variable ‘level of the water in the boiler’.

The above discussed procedure may be followed to investigate any of the variables in the example system, and repeated iterations at different time instances for variables demonstrating a dependency change between the reference and operational data set may allow for the identification not only of fault data but also the precise tie at which the fault occurred. On the basis of the analysis, a likely source of the data fault may also be identified, allowing for the regeneration of an alarm and/or appropriate recommendations or actions to address the fault.

For the sake of comparison, the system is also analyzed using a conventional method set out in Reppa, Vasso, Marios M. Polycarpou, and Christos G. Panayiotou (2016). Sensor fault diagnosis, Foundations and Trends® in Systems and Control, 1-248. The analysis according to the method set out in Reppa et al. fails to identify the artificially inserted fault in the data. Examples of the present disclosure this provide a more effective way of identifying non-anomalous fault sin system data. Examples of the present disclosure additionally allow for the identification of a factor or variable likely to be the cause of the fault in the data, allowing for remedial action to the taken.

The computation complexity of examples of the present disclosure is discussed below. The adjacency matrix, or graph, for the reference data set is computed once and stored in a database. An adjacency matrix or graph is then computed for operational data sets at scheduled or periodic time intervals, for example every 2, 5 or 10 minutes. This calculation of adjacency matrix requires calculation of conditional mutual information and conditional correlation. On a local machine of i5-4^{th} gen with RAM of 8 GB, an adjacency matrix of size 6×6 takes approximately 1 second to compute (as it have analytical expressions). An optimization problem for determining optimal weight values takes approximately 2 seconds (linear programming) to compute the optimal weights. This can be done on normal raspberry pi which can be performed in the edge network, as the computation is not overly costly. Notifications may be sent only when faults are detected, or may be sent on a periodic basis, confirming that a method for fault detection is being performed.

Example systems in which methods according to the present disclosure may be implemented encompass a wide range of industrial, commercial and other systems, including factories, laboratories, manufacturing plants, power stations etc. Another example system in which the methods according to the present disclosure may be implemented is a mine. The Pueblo Viejo mine is a gold mine located in the north-central region of the Dominican Republic in the Sánchez Ramírez Province. At Pueblo Viejo, the gold is extracted by injecting high-purity oxygen into autoclaves operating at 230° C. and 40 bar of pressure. The resulting chemical reactions oxides the sulfide minerals the gold is trapped within. The mine authorities use controllers such as a PID controller to control the temperature and pressure within the mine. These controllers perform certain actuations based on sensor measurements of the temperature and pressure. Any faults in the temperature and pressure measurements can result in incorrect actuations being performed, with potentially catastrophic consequences. The temperature in the mine is affected by a range of variables including as coolant flow, number of people in the mine etc. Any fault in temperature data as a consequence of the temperature or any of the other variables which may affect the temperature measurements, can be identified online during operation of the mine using examples of the present disclosure, so allowing for corrective measures to be taken to avoid a potential accident.

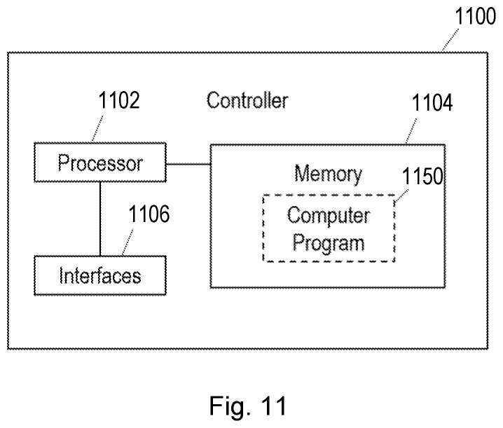

FIG. 10 is a system flow diagram summarizing an implementation of methods according to examples of the present disclosure. With reference to FIG. 10, information from a system or plant 1002 and data obtained during an installation phase 1004 are obtained to allow for calculation of adjacency matrices for operational and reference data set respectively. A difference matrix is calculated at 1006 and the difference matrix is compared to a fault threshold at 1008. If the difference matrix does not exceed the fault threshold, then the system is operating correctly. If the difference matrix exceeds the threshold, then an optimization is performed at 1010 for the weights used in computing the metric for constructing the adjacency matrices. An updated difference matrix is then compared to the fault threshold at 1012. If the difference matrix does not exceed the fault threshold, then the system is operating correctly, and the previous result was a consequence of non-optimal weights. If the difference matrix exceeds the threshold, then a fault is deemed to be present in the data and an alarm is triggered.

As discussed above, the methods 200, 300 may be performed by a controller, which may for example be a management node in an IoT system, and may be a physical node or a Virtualised Network Function. FIG. 11 is a block diagram illustrating an example controller 1100 which may implement the methods 200, 300 according to examples of the present disclosure, for example on receipt of suitable instructions from a computer program 1150. Referring to FIG. 11, the controller 1100 comprises a processor or processing circuitry 1102, a memory 1104 and interfaces 1106. The memory 1104 contains instructions executable by the processor 1102 such that the controller 1100 is operative to conduct some or all of the steps of the method 200 and/or 300. The instructions may also include instructions for executing one or more telecommunications and/or data communications protocols. The instructions may be stored in the form of the computer program 1150. In some examples, the processor or processing circuitry 1102 may include one or more microprocessors or microcontrollers, as well as other digital hardware, which may include digital signal processors (DSPs), special-purpose digital logic, etc. The processor or processing circuitry 1102 may be implemented by any type of integrated circuit, such as an Application Specific Integrated Circuit (ASIC), Field Programmable Gate Array (FPGA) etc. The memory 1104 may include one or several types of memory suitable for the processor, such as read-only memory (ROM), random-access memory, cache memory, flash memory devices, optical storage devices, solid state disk, hard disk drive etc.

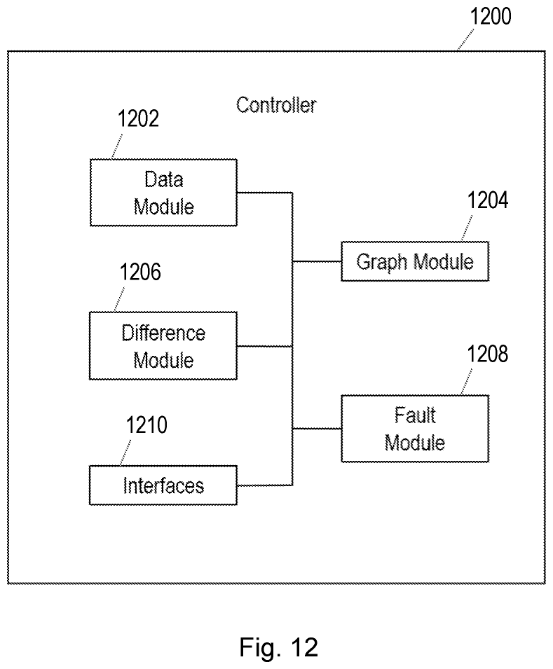

FIG. 12 illustrates functional units in another example of controller 1200 which may execute examples of the methods 200, 300 of the present disclosure, for example according to computer readable instructions received from a computer program. It will be understood that the units illustrated in FIG. 12 are functional units, and may be realised in any appropriate combination of hardware and/or software. The units may comprise one or more processors and may be integrated to any degree.

Referring to FIG. 12, the controller 1200 is for identifying a fault in data representing a target variable of a system, wherein the system comprises a plurality of variables, and wherein each variable is represented by a data stream. The controller 1200 comprises a data module 1202 for obtaining a reference data set for a set of variables in the system including the target variable and for obtaining an operational data set for the set of variables in the system including the target variable. The controller 1200 further comprises a graph module for constructing an adjacency matrix between the target variable and the other variables in the set of variables for each of the reference and operational data sets, wherein the adjacency matrix is constructed on the basis of a metric calculated between the target variable and the other variables of the set. The controller 1200 further comprises a difference module for calculating a difference matrix between the adjacency matrices for the reference and operational data sets. The controller 1200 further comprises a fault module 1208 for determining whether the data representing the target variable in the operational data set includes a fault on the basis of a comparison between the calculated difference matrix and a fault threshold. The controller 1200 further comprises interfaces 1210. The term module may have conventional meaning in the field of electronics, electrical devices and/or electronic devices and may include, for example, electrical and/or electronic circuitry, devices, processors, processing circuitry, memories, logic, solid state and/or discrete devices, computer programs or instructions for carrying out respective tasks, procedures, computations, outputs, and/or displaying functions, and so on, as such as those that are described in the present disclosure.

Examples of the present disclosure thus provide an efficient method for detection of faults in system data, which method is particularly effective at detecting non-anomalous faults, which are generally must more difficult to identify. The identification of such faults may help in improving decisions taken on the fly during operation.

In any industrial or commercial system variables may be present in the system and various sensors may be used to measure them. For example, there are some situations where both temperature and pressure are to be monitored. In this case, the temperature readings can be affected by change in pressure and vice-versa. As an example, it may be required to switch on the heater inside a boiler whenever the temperature of the boiler falls below a threshold temperature. Any fault in the temperature sensor can result in switching on the heater even if the true temperature is higher than the threshold. Identifying faulty temperature data, and so avoiding an incorrect action being taken on the basis of this data, can ensure that faulty temperature data is identified before the heater is switched on, saving power consumption. For a large network with thousands of sensors, estimating the interaction between sensors is challenging. Examples of the present disclosure propose a robust method to estimate and represent the interaction between variables and on this basis identify faults in any of the variables.

According to examples of the present disclosure, two adjacency matrices are constructed, reflecting connections between variables on the basis of a metric which may comprise a combination of conditional correlation and conditional mutual information. A first adjacency matrix is constructed for a reference data set obtained when expectation of faults in the data is low (at installation or through performing a de-noising exercise). A second adjacency matrix is constructed for an operational data set obtained during live operation of the system. A difference between the adjacency matrices is calculated to obtain a difference matrix S. On the basis of the difference matrix, an optimisation process may be used to calculate optimal weights for a metric that is a weighted sum of conditional correlation and conditional mutual information. Once the optimal weights have been calculated, the difference matrix may be updated and compared to a fault threshold to determine if the difference matrix indicates the presence of a fault in the data.

Examples of the present disclosure may offer one or more of the following advantages:

A generalised fault identification method able to consider all factors affecting a target variable to provide alarm or recommendations on identifying a fault.

A method capable of identifying different types of data faults in an unsupervised manner.

A robust metric for adjacency matrix construction which enable the identification of faults which would otherwise not be identified, and is able to distinguish between direct an indirect dependencies between variables.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for identifying a fault in data representing a target variable of a system, wherein the system comprises a plurality of variables, and wherein each variable is represented by a data stream, the method comprising:
obtaining a reference data set for a set of variables in the system including the target variable;
obtaining an operational data set for the set of variables in the system including the target variable;
for each of the reference data set and the operational data set:
constructing an adjacency matrix between the target variable and other variables in the set of variables, wherein the adjacency matrix is constructed on the basis of a metric calculated between the target variable and the other variables of the set;
calculating a difference matrix between the adjacency matrices for the reference and operational data sets; and
determining whether the data representing the target variable in the operational data set includes a fault on the basis of a comparison between the calculated difference matrix and a fault threshold.

2. The method of claim 1, wherein the metric comprises a combination of conditional correlation and conditional mutual information between the target variable and the other variables in the set.

3. The method of claim 1, wherein the metric comprises a weighted sum of conditional correlation and conditional mutual information between the target variable and the other variables in the set.

4. The method of claim 2, wherein conditional correlation between the target variable X and another variable Y is calculated by iteratively solving the following formula:
$$ρ [ k ] = \frac{σ [ k ] - {\sum }_{l = 1}^{k - 1} ρ [ l ] σ [ k - l ]}{1 - {\sum }_{l = 1}^{k - 1} ρ [ l ] σ [ k - l ]} \qquad$$
where: σ[k] is the value of the correlation between X and Y obtained at lag k using the equation:
$${σ}_{xy} = \frac{E ( ( X - {μ}_{x} ) ( Y - {μ}_{y} ) )}{{σ}_{x} {σ}_{y}}$$
where: σₓ,σ_{y} a are the standard deviation of the variables X and Y, and
μₓ,μ_{y} are the mean of the variables X and Y.

5. The method of claim 2, wherein conditional mutual information between the target variable X and another variable Y conditional upon a third variable Z is calculated using the following formula:
$$I ( X ; Y \vert Z ) = {\sum }_{z ∈ Z} {\sum }_{y ∈ Y} {\sum }_{x ∈ X} {p}_{X , Y , Z} ( x , y , z ) log \frac{{p}_{Z} ( z ) {p}_{X , Y , Z} ( x , y , z )}{{p}_{X , Z} ( x , z ) {p}_{Y , Z} ( y , z )}$$
where: p_{Z}[z] is the probability mass function of variable Z, and
p_{X,Y,Z}[x, y, z] is the joint probability mass function of variables X, Y, Z

6. The method of claim 3, wherein constructing the adjacency matrices comprises using values of weights for the weighted sum that are at least one of:
default values;
values selected on the basis of a hypothesis as to the relative importance of conditional correlation and conditional mutual information for the target variable; or
values based on an optimization calculation.

7. The method of claim 1, wherein calculating a difference matrix comprises subtracting the adjacency matrix for the operational data set from the adjacency matrix for the reference data set.

8. The method of claim 1, wherein determining whether the data representing the target variable in the operational data set includes a fault on the basis of a comparison between the calculated difference matrix and a fault threshold comprises:
performing a comparison between the calculated difference matrix and the fault threshold; and
if the calculated difference matrix does not exceed the fault threshold, determining that the data representing the target variable in the operational data set does not include a fault.

9. The method of claim 8, wherein determining whether the data representing the target variable in the operational data set includes a fault on the basis of a comparison between the calculated difference matrix and a fault threshold further comprises:
if the calculated difference matrix exceeds the fault threshold, determining that the data representing the target variable in the operational data set includes a fault.

10. The method of claim 8, wherein
the metric comprises a weighted sum of conditional correlation and conditional mutual information between the target variable and the other variables in the set, and
determining whether the data representing the target variable in the operational data set includes a fault on the basis of a comparison between the calculated difference matrix and a fault threshold further comprises:
if the difference matrix exceeds the fault threshold:
performing an optimisation of the values of the weights for the weighted sum;
constructing an updated adjacency matrix for each of the reference and operational data sets; wherein the updated adjacency matrices are constructed on the basis of a metric calculated using the optimised weight values;
recalculating the difference matrix on the basis of the updated adjacency matrices for the reference and operational data sets;
performing a comparison between the recalculated difference matrix and the fault threshold; and
if the recalculated difference matrix does not exceed the fault threshold, determining that the data representing the target variable in the operational data set does not include a fault.

11. The method of claim 10, further comprising:
if the recalculated difference matrix exceeds the fault threshold, determining that the data representing the target variable in the operational data set includes a fault.

12. The method of claim 8, wherein the fault threshold comprises a value; wherein performing a comparison between a difference matrix and the fault threshold comprises comparing each entry in the difference matrix to the value of the fault threshold; and wherein the difference matrix exceeds the fault threshold if at least one entry in the difference matrix exceeds the value of the fault threshold.

13. The method of claim 12, further comprising, if an entry in the difference matrix exceeds the value of the fault threshold:
determining that the data representing the target variable in the operational data set includes a fault, and that the source of the fault in the data is the variable corresponding to the entry in the difference matrix that exceeds the threshold value.

14. The method of claim 12, further comprising, if every entry in the difference matrix exceeds the value of the fault threshold:
determining that the data representing the target variable in the operational data set includes a fault, and that the source of the fault in the data is the target variable.

15. The method of claim 1, wherein the fault threshold is selected to account for expected statistical variation in the data.

16. The method of claim 1, wherein constructing an adjacency matrix between the target variable and the other variables in the set of variables comprises:
filtering the other variables in the set of variables according to the value of the metric calculated between the target variable and the other variables of the set; and
including in the adjacency matrix those other variables of the set of variables that have a value of the calculated metric above an inclusion threshold.

17. The method of claim 10, wherein performing an optimization of the values of the weights for the weighted sum comprises:
obtaining a plurality of operational data sets for the set of variables in the system including the target variable, the plurality of operational data sets including data for the set of variables at different times during operation of the system;
constructing an adjacency matrix between the target variable and the other variables in the set of variables for each of the plurality of operational data sets;
for each of the plurality of operational data sets, calculating a difference matrix between the adjacency matrices for the reference and operational data sets; and
identifying values for the weights for the weighted sum that minimize the sum, over all of the operational data sets, of the sum of all entries in each difference matrix.

18. The method of claim 17, wherein identifying values for of the weights for the weighted sum that minimize the sum, over all of the operational data sets, of the sum of all entries in each difference matrix comprises solving the optimization problem:
$$\begin{matrix}min \\ {w}_{1} , {w}_{2}\end{matrix} {\sum }_{i = 1}^{{N}_{s}} \sum {δ}_{i} such that \begin{matrix}0 \leq {w}_{1} \leq 1 \\ 0 \leq {w}_{2} \leq 1 \\ {w}_{1} + {w}_{2} = 1\end{matrix}$$
where: Nₛ is the number of operational data sets;
δᵢ is the difference matrix for operational data set i; and
w₁ and w₂ are the weights of the weighted sum.

19. The method of claim 1, further comprising, if it is determined that the data representing the target variable in the operational data set includes a fault:
repeating the steps of the method for operational data sets at different time instances to identify the time instance at which the difference matrix first exceeds the fault threshold.

20-26. (canceled)

27. A controller for identifying a fault in data representing a target variable of a system, wherein the system comprises a plurality of variables, and wherein each variable is represented by a data stream, the controller comprising a processor and a memory, the memory containing instructions executable by the processor such that the controller is operable to:
obtain a reference data set for a set of variables in the system including the target variable;
obtain an operational data set for the set of variables in the system including the target variable;
for each of the reference data set and the operational data set:
construct an adjacency matrix between the target variable and other variables in the set of variables, wherein the adjacency matrix is constructed on the basis of a metric calculated between the target variable and the other variables of the set;
calculate a difference matrix between the adjacency matrices for the reference and operational data sets; and
determine whether the data representing the target variable in the operational data set includes a fault on the basis of a comparison between the calculated difference matrix and a fault threshold.

28-30. (canceled)
